(19) United States
(12) Patent Application Publication
(10) Pub. No.: US 2022/0274196 A1
(43) Pub. Date: Sep. 1, 2022

(54) Method and Device for Stabilizing a Transition between Various Welding-Process Phases of a Welding Process

(71) Applicant: Fronius International GmbH, Pettenbach (AT)

(72) Inventors: Dominik Söllinger, Pettenbach (AT); Andreas Waldhör, Pettenbach (AT); Manuel Mayer, Pettenbach (AT)

(21) Appl. No.: 17/632,546

(22) PCT Filed: Aug. 6, 2020
(86) PCT No.: PCT/EP2020/072207

§ 371 Date: Feb. 3, 2022

(30) Foreign Application Priority Data
Aug. 6, 2019 (EP) 19190384.8

(51) Int. Cl. B23K 9/073; B23K 9/095

(52) U.S. Cl. CPC B23K 9/0735; B23K 9/0953

(57) ABSTRACT

Welding device (1) for welding a workpiece (W) in a welding process (SP) which comprises different types of welding process phases (SPP), in which the workpiece (W) is welded in each case with a welding arc (LB) which extends between a welding wire electrode (SDE) of the welding device (1) and the workpiece (W), wherein for the welding process phases (SPP) an arc parameter, LBP, of the welding arc (LB), in particular its arc length, LBL, can be set, wherein the welding device (1) comprises a controller (4) which, during a welding process transition (SPÜ) between different types of welding process phases (SPP) of the welding process (SP), effects a change in the arc parameter, ΔLBP, of the welding arc (LB) corresponding to the arc parameters, LBP, set for the welding process phases (SPP) and at the same time automatically adapts at least one transition welding parameter, ÜSP, of a welding current source (2) of the welding device (1) in dependence upon the effected arc parameter change, ΔLBP, in order to stabilize the welding process phase transition (SPÜ) within the welding process (SP).

### PRIORITY CLAIM

This application is a 35 U.S.C. § 371 National Stage Application of PCT/EP2020/072207, filed on Aug. 6, 2020, which claims the benefit of priority to Serial No. EP 19190384.8, filed on Aug. 6, 2019 in Europe, the disclosures of which are incorporated herein by reference in their entirety.

### TECHNICAL FIELD

The invention relates to a method and a device for stabilizing a transition between different types of welding process phases of a welding process, in particular in arc welding processes.

### TECHNICAL BACKGROUND

In arc welding, a welding arc burns between a workpiece and a welding wire electrode. The welding wire electrode can thus melt and serve as a filler material. In gas-shielded welding, the arc is shielded from the atmosphere by a shielding gas such as carbon dioxide or argon. The welding wire electrode, which continuously melts, is progressively pulled from a spool of wire. In this case, the welding wire electrode extends in a hose, through which the shielding gas is also supplied. In MIG welding, metal inert gas welding, inert shielding gases are used. In contrast, in MAG welding, metal active gas welding, reactive gases such as carbon dioxide are used as the shielding gas.

Different welding parameters in particular arc length, influence the result of the welding process. Short arc welding is used in the case of thin metal sheets or difficult welding sites. In this case, a smooth transition with few breaks is produced between the materials. In contrast, long arc welding is mainly used in the case of thicker metal sheets.

In the case of gas metal arc welding, GMAW, i.e. either MIG or MAG welding, a consumable welding wire electrode is used, this being able to be fed at a variable wire advancing rate by an electric motor. The welding wire electrode is melted differently by the welding arc according to the set welding parameters.

In welding by pulsed arc welding, a higher pulse current is regularly superimposed on a background current. During the background current phase, the arc or welding arc burns at low power, wherein the filler material is melted and the weld pool is kept liquid. In the pulsed phase, a droplet forms which is released by the increasing magnetic pinching (pinch effect). The setting values can be selected depending on the wire diameter of the welding wire electrode and the material of the welding wire electrode in such a way that a droplet is generated and released during each current pulse. Depending on the set welding voltage and the set welding current as well as the set arc length, it is possible to distinguish between different types of arc, as generally known from the prior art. The different types of arc include a short arc, a long arc and a pulsed arc and a so-called spray arc as well as a rotating arc. The wire can be advanced both in the direction of the workpiece and also in the opposite direction.

In many applications, it is necessary to switch between different welding process phases. The different welding process phases have different welding parameters and/or arc types. In many welding processes, there is a cyclical switch between different welding process phases. However, in conventional welding processes, the difficulty arises of stabilizing a process transition from one welding process phase to the following welding process phase of the welding process. Such instabilities in switching between different welding process phases can have negative effects on the welding result, in particular with respect to the appearance of the weld seam formed or weld spatter which occurs. Accordingly there is a need to provide a method and a device for stabilizing a transition between different types of welding process phases of a welding process.

### SUMMARY OF THE INVENTION

The invention accordingly provides according to an aspect a method for stabilizing a transition between different types of welding process phases of a welding process, wherein, at least in the welding process phases, a workpiece is welded with a respective welding arc which extends between a welding wire electrode and the workpiece, and has an arc length parameter which can be set for the at least one welding process phase, wherein for the transition between successive different types of welding process phases in the case of a change in the set arc length parameter of the welding arc, in parallel thereto at least one transition welding parameter is automatically adapted in dependence upon the effected arc length parameter change in order to stabilize the welding process phase transition.

In a possible embodiment of the method in accordance with an aspect of the invention for stabilizing a transition between different types of welding process phases of a welding process, the transition welding parameters comprise a wire advancing rate of the consumable welding wire electrode.

In a further possible embodiment of the method in accordance with an aspect of the invention for stabilizing a transition between different types of welding process phases of a welding process, the transition welding parameters comprise an amplitude and/or a polarity of the average welding current flowing through the welding wire electrode.

In a further possible embodiment of the method in accordance with an aspect of the invention for stabilizing a transition between different types of welding process phases of a welding process, the transition welding parameters comprise an amplitude and/or a polarity of the welding voltage applied between the welding wire electrode and the workpiece.

In a further possible embodiment of the method in accordance with an aspect of the invention for stabilizing a transition between different types of welding process phases of a welding process, the transition welding parameters comprise a number and/or a frequency of pulses of the welding current flowing through the welding wire electrode.

In a further possible preferred embodiment of the method in accordance with an aspect of the invention, the arc parameter comprises an arc length of the welding arc.

In a possible embodiment of the method in accordance with an aspect of the invention for stabilizing a transition between different types of welding process phases of a welding process, with increasing or decreasing effected arc length change the wire advancing rate and/or the acceleration of the consumable welding wire electrode is/are automatically increased or reduced as transition welding parameters for stabilizing the welding process phase transition.

In a further possible embodiment of the method in accordance with an aspect of the invention for stabilizing a transition between different types of welding process phases of a welding process, with increasing or decreasing effected arc length change the amplitude and/or duration of the welding current and/or the amplitude and/or duration of the welding voltage is/are automatically increased or reduced.

In a further possible embodiment of the method in accordance with an aspect of the invention for stabilizing a transition between different types of welding process phases of a welding process, with increasing or decreasing effected arc length change the number and/or the frequency of pulses of the welding current is/are automatically reduced or increased.

In a further possible embodiment of the method in accordance with an aspect of the invention for stabilizing a transition between different types of welding process phases of a welding process, for different combinations of pairs of successive different types of welding process phases of the welding process, in each case for different arc parameter changes which can be effected, associated configurable welding parameter sets of transition welding parameters are stored in tabular form in a parameter data store.

In a further possible embodiment of the method in accordance with an aspect of the invention for stabilizing a transition between different types of welding process phases of a welding process, in dependence upon the effected arc parameter change and upon the combination of the two successive different types of welding process phases the associated welding parameter set is read out from the parameter data store and the corresponding transition welding parameters are adapted in order to stabilize the welding process phase transition between the two welding process phases.

In a further possible embodiment of the method in accordance with an aspect of the invention for stabilizing a transition between different types of welding process phases of a welding process, for different combinations of pairs of successive different types of welding process phases of the welding process transition function characteristic curves are provided for different transition welding parameters.

In a further possible embodiment of the method in accordance with an aspect of the invention for stabilizing a transition between different types of welding process phases of a welding process, in dependence upon the effected arc parameter change and upon the associated stored transition function characteristic curves parameter values for the different transition welding parameters are calculated during the welding process phase transition and the transition welding parameters are automatically adapted according to the calculated parameter values in order to stabilize the welding process phase transition.

In a further possible embodiment of the method in accordance with an aspect of the invention, the different welding process phases of the welding process comprise:

a short arc welding phase,
a long arc welding phase,
a pulsed arc welding phase,
a short arc welding phase with forwards or backwards movement,
a spray arc welding phase and/or
a welding phase with a rotating arc, and/or a transition arc phase.

The invention provides according to a further aspect a welding device for welding a workpiece in a welding process which comprises different types of welding process phases in which the workpiece is welded with a welding arc which extends between a welding wire electrode of the welding device and the workpiece, wherein for the welding process phases an arc parameter of the welding arc, in particular its arc length, can be set, wherein the welding device comprises a controller which, during a transition between different types of welding process phases of the welding process, effects a change in the arc parameter of the welding arc corresponding to the arc parameters set for the welding process phases and at the same time automatically adapts at least one transition welding parameter of a welding current source of the welding device in dependence upon the effected arc parameter change in order to stabilize the welding process phase transition within the welding process.

In a possible embodiment of the welding device in accordance with the further aspect of the invention, for different welding process phases of the welding process respective associated arc parameter target values for the arc parameter to be used are preset, which can each be manually adjusted and readjusted within preset limits by a user using a setting element.

The arc parameter target values, in particular for the arc length, can also be provided via an interface from an external superordinate controller or a robot controller.

In a further possible embodiment of the welding device in accordance with the further aspect of the invention, for different combinations of pairs of successive different types of welding process phases of the welding process, in each case for different arc parameter changes which can be effected, associated configurable welding parameter sets of transition welding parameters are stored in tabular form in a parameter data store of the welding device.

In a further possible embodiment of the welding device in accordance with the further aspect of the invention, in dependence upon the effected arc parameter change and upon the combination of the two successive different types of welding process phases the associated welding parameter set is read out from the parameter data store of the welding device and the corresponding transition welding parameters are adapted automatically by the controller of the welding device in order to stabilize the welding process phase transition between the two welding process phases.

In a further possible embodiment of the welding device in accordance with the further aspect of the invention, for different combinations of pairs of successive different types of welding process phases of the welding process transition function characteristic curves are provided for different transition welding parameters.

In a possible embodiment of the welding device in accordance with the further aspect of the invention, in dependence upon the effected arc parameter change and the associated stored transition function characteristic curves parameter values for the different transition welding parameters are calculated during the welding process phase transition by a computing unit of the controller of the welding device and the transition welding parameters are automatically adapted by the controller of the welding device in order to stabilize the welding process phase transition.

In a further possible embodiment of the welding device in accordance with the further aspect of the invention, the welding device comprises an interface for loading welding parameter sets of the transition welding parameters and/or for loading transition function characteristic curves from a database.

### BRIEF DESCRIPTION OF FIGURES

Possible embodiments of the method in accordance with the invention and of the device in accordance with the invention for stabilizing a transition between different types of welding process phases of a welding process are explained in more detail hereinafter with reference to the attached figures.

FIG. 1 shows a schematic block circuit diagram to explain the manner of operation of a welding device in accordance with the invention;

FIG. 2 shows a diagram to explain the manner of operation of the method in accordance with the invention and of the device in accordance with the invention for stabilizing a transition between different types of welding process phases of a welding process;

FIGS. 3A, 3B, 3C show by way of example, welding processes with cyclically alternating welding process phases in order to explain the manner of operation of the method in accordance with the invention and of the device in accordance with the invention for stabilizing a transition between different types of welding process phases of a welding process.

### DETAILED DESCRIPTION OF EMBODIMENTS

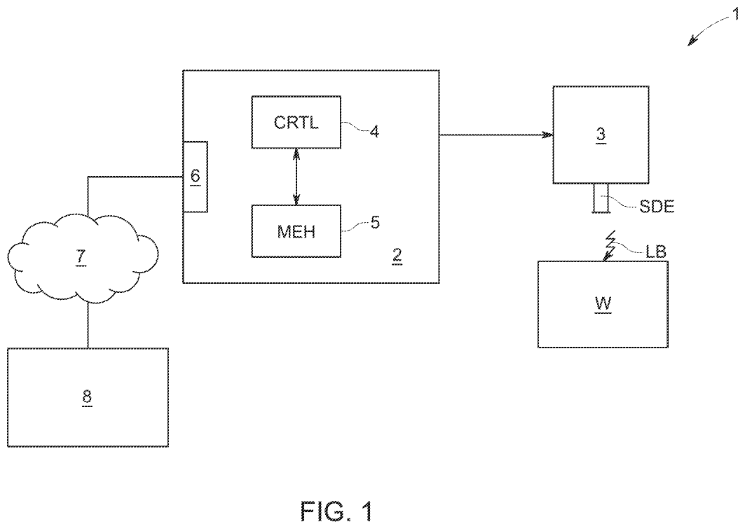

As shown in FIG. 1, according to one aspect of the invention a welding device 1 comprises a welding current source 2 which supplies a welding current and a welding voltage to a welding torch 3 of the welding device 1. The welding torch 3 can have a shielding gas nozzle. A welding wire electrode SDE can be fed out of a contact pipe of the welding torch 3 in order to weld a workpiece W. Between the welding wire electrode SDE and the workpiece W, a welding arc LB is produced, as shown in FIG. 1. The welding device 1 serves to weld the workpiece W in a welding process SP which can comprise different types of welding process phases SPP in which the workpiece W is welded in each case using the welding arc LB. Arc parameters LBP of the welding arc LB, in particular its arc length LBL, can be set for the different welding process phases SPP. The welding device 1 comprises a controller 4 which, during a transition between different types of welding process phases SPP of the welding process SP, effects a change in an arc length parameter LBLP of the welding arc SLB according to the arc parameters LBP set for the welding process phases SPP. The controller 4 at the same time automatically adapts at least one transition welding parameter ÜSP of the welding current source 2 of the welding device 1 in dependence upon the effected arc length parameter change ΔLBLP in order to stabilize the welding process transition SPÜ within the welding process SP. The welding current source 4 can have an interface 6. By means of the interface 6 and a network 7, the local controller 4 of the welding current source 2 can receive control commands and/or target parameter settings from an external superordinate controller 8, e.g. an automation system.

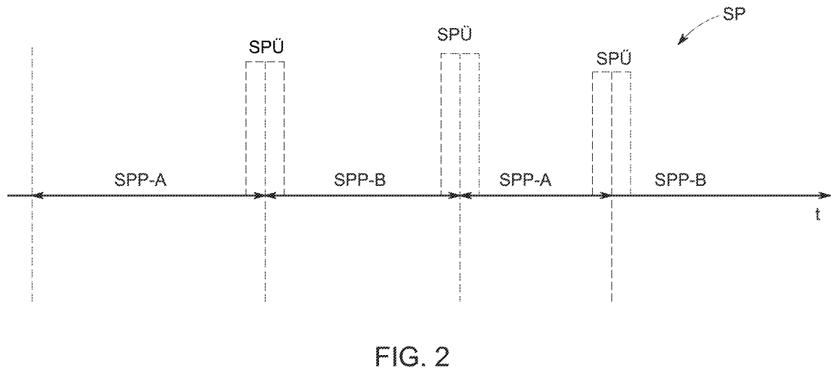

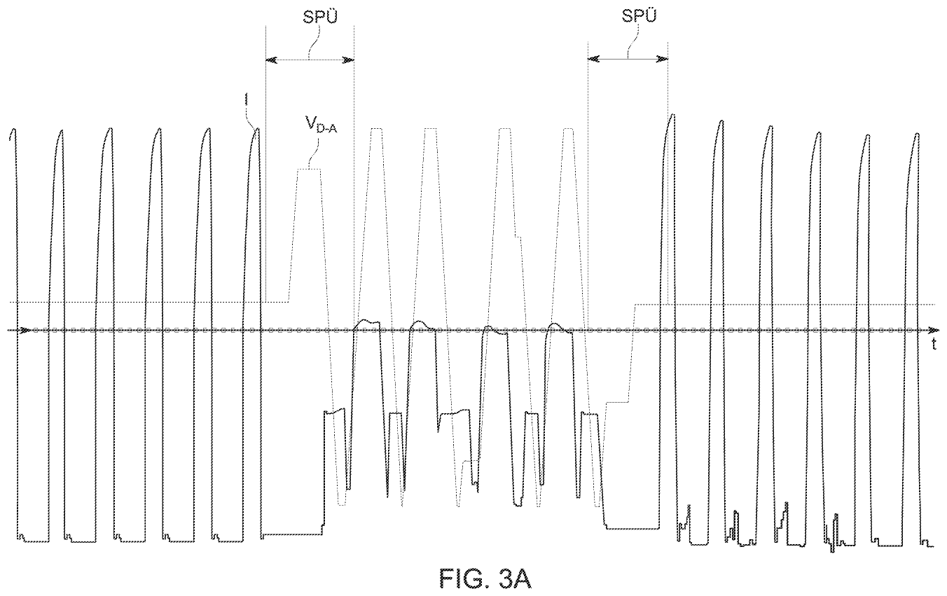

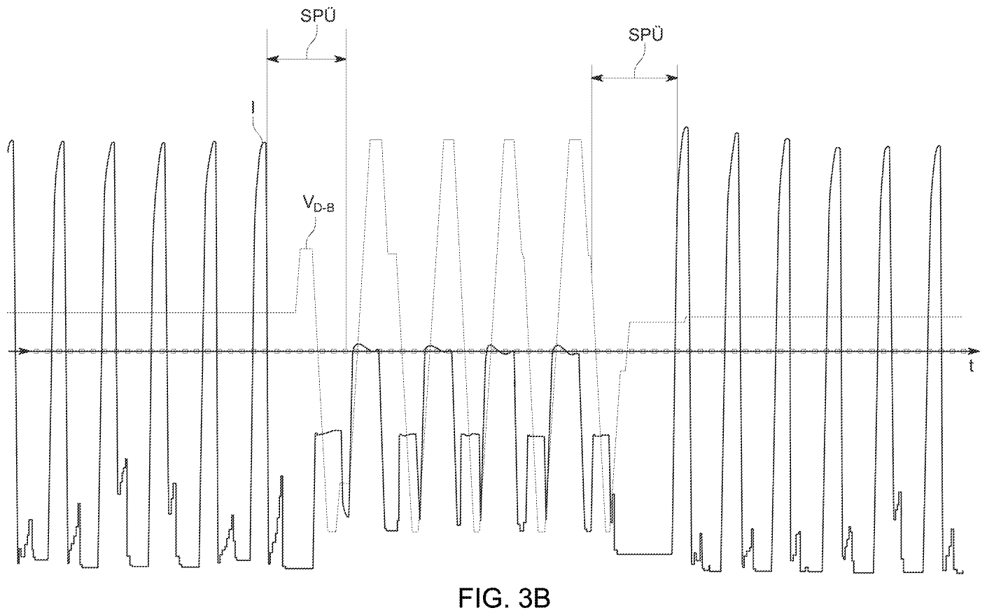

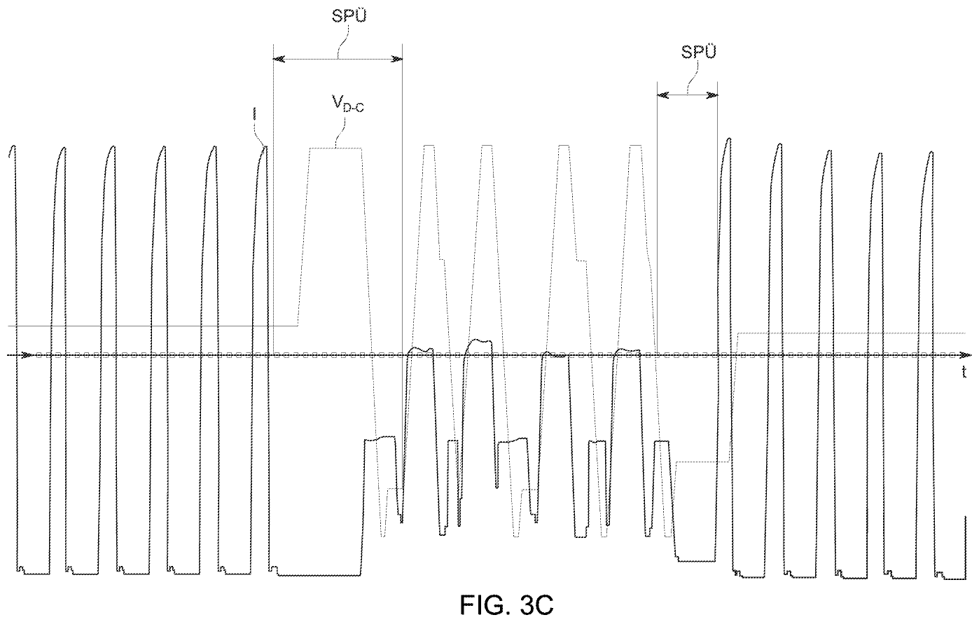

FIG. 2 schematically shows a welding process SP which consists of a series of various different welding process phases SPP. The different welding process phases SPP can comprise e.g. a short arc welding phase, a short arc welding phase with reversing wire movement (CMT), a long arc welding phase, a pulsed arc welding phase, a spray arc welding phase and/or a welding phase with a rotating arc. The sequence of the different types of welding process phases SPP can differ according to the welding process SP. For example, two different types of welding process phases SPP, e.g. the welding process phase SPP-A and the welding process phase SPP-B, can alternate cyclically as shown by way of example in FIG. 3A. For example, a pulsed arc welding phase can alternate cyclically with a short arc welding phase. Of course, three or more welding process phases SPP can also alternate with each other (not illustrated).

FIG. 2 also schematically shows the different welding process transitions SPÜ between the welding process phases SPP of a welding process. In the welding process transitions SPÜ the transition welding parameters ÜSP are adapted or regulated. The duration of the welding process transition SPÜ and the group of the transition welding parameters ÜSP therein adapted depend upon the two relevant welding process phases SPP, between which the welding process transition SPÜ takes place.

For the different welding process phases SPP of the welding process SP it is possible for respectively associated arc parameter target values, in particular arc length target values, to be preset for the arc parameters LBP to be used. These presettings can each be manually adjusted or readjusted or corrected within preset limits by a user using a setting element at the welding current source 2. Alternatively, the presettings can be effected via an interface by the external controller 8.

For different combinations of pairs of successive different types of welding process phases SPP of the welding process SP, in each case for different arc length parameter changes SLBLP which can be effected, associated configurable welding parameter sets of transition welding parameters ÜSP can be stored in tabular form in a parameter data store 5 of the welding device 1. In one possible embodiment, the transition welding parameters ÜSP are loaded from a database into the local data store 5 of the welding current source 2 via an interface. In dependence upon the effected arc length parameter change ΔLBLP and the combination of the two successive different types of welding process phases SPP, the associated welding parameter set is read out from the parameter data store 5 of the welding device 1 and the corresponding transition welding parameters ÜSP are automatically adapted or regulated by a controller 4 of the welding device 1 in order to stabilize the welding process phase transition SPÜ concerned between the two welding process phases SPP.

In a further possible embodiment of the welding device 1 in accordance with the invention, for different combinations of pairs of successive different types of welding process phases SPP of the welding process SP transition function characteristic curves can be provided for different transition welding parameters ÜSP. In dependence upon the effected arc length parameter change ΔLBLP and the associated stored transition function characteristic curves, parameter values for the different transition welding parameters ÜSP are calculated during the welding process phase transition SPÜ by a computing unit of the controller 4 of the welding device 1 and the transition welding parameters ÜSP are automatically adapted by the controller 4 of the welding device 1 in order to stabilize the welding process phase transition SPÜ. The welding device 1 preferably has an interface for loading welding parameter sets of the transition welding parameters ÜSP and/or for loading transition function characteristic curves from a database. This database can be connected to an interface of the welding device 1 e.g. via a data network.

Different transition welding parameters ÜSP can be automatically adapted by the method in accordance with the invention and the device in accordance with the invention in dependence upon an effected arc parameter change, in particular an arc length change, in order to stabilize the welding process phase transition SPÜ between two successive welding process phases SPP of the same welding process SP. In one possible embodiment, these transition welding parameters ÜSP comprise a wire advancing rate V_{D} of the welding wire electrode SDE and/or a wire advancing acceleration a_{D} of the welding wire electrode SDE. Furthermore, the transition welding parameters ÜSP can have an amplitude and/or a polarity of the average welding current I flowing through the welding wire electrode SDE. In a further possible embodiment, the transition welding parameters ÜSP have an amplitude and/or a polarity of the welding voltage U applied between the welding wire electrode SDE and the workpiece W. In a further possible embodiment of the method in accordance with the invention and of the device in accordance with the invention, the transition welding parameters ÜSP have a number and/or frequency of pulses of the welding current I flowing through the welding wire electrode SDE.

With a positively (+5) effected arc length change ΔLBL or arc length parameter change ΔLBLP the wire advancing rate V_{D} of the consumable welding wire electrode SDE is automatically increased by the controller 4 as a transition welding parameter ÜSP in order to stabilize the welding process phase transition SPÜ between two welding process phases SPP of the welding process SP. Conversely, in the case of a negatively effected arc length change ΔLBL the wire advancing rate V_{D} of the consumable welding wire electrode SDE is automatically reduced as a transition welding parameter ÜSP in order to stabilize the welding process phase transition SPÜ. The arc length change ΔLBL can take place e.g. using a correction value. In this case, a correction value of 0 means that no change in the arc length LBL takes place. In the case of a change in a positive direction, the arc length LBL is increased accordingly, and in a negative direction it is reduced accordingly. This is described hereinunder by way of example using correction values of −5, 0 and +5.

In a further possible embodiment of the method in accordance with the invention and of the device in accordance with the invention, in the case of increasing effected (positive) arc length change ΔLBL the amplitude and/or the duration of the welding current I and/or the amplitude and/or the duration of the welding voltage U are automatically reduced. Conversely, in the case of decreasing effected (negative) arc length change ΔLBL, the amplitude and/or the duration of the welding current I and/or the amplitude and/or the duration of the welding voltage U are automatically increased.

Furthermore, in one possible embodiment, with increasing effected arc length change ΔLBL the number and/or frequency of pulses of the welding current I are automatically reduced. Conversely, in the case of decreasing effected arc length change ΔLBL the number and/or frequency of pulses of the welding current I are automatically increased.

FIGS. 2 and 3 show an exemplified embodiment of a welding process SP with two cyclically alternating welding process phases SPP-A, SPP-B with different welding parameters, in particular a welding voltage U, a welding current I and a wire advancing rate V_{D}. The transition welding parameters ÜSP can be adapted to the arc lengths LBL of the welding process phases A, B. In the case of a manual or remote-controlled change or readjustment or correction of the arc length setting, instabilities can arise which are avoided or remedied by the method in accordance with the invention. Specifically, this means that the duration of the welding process transitions SPÜ is substantially unchanged, in particular not lengthened, by the change in the arc length LBL.

In parallel to an arc length correction brought about by manual readjustment, a correction takes place with the aid of the method in accordance with the invention in the transition welding parameters Ü SP, in particular the wire advancing rate V_{D} of the welding current I, and the progress thereof over time. This is to be understood to mean that, in the welding process transition SPÜ, the wire advancing rate vd is briefly increased in order to initiate a short circuit KS more quickly, and then the welding wire electrode SDE is moved backwards. Alternatively, the wire advancing rate vd can be changed in a stepped manner. The values of the parameters are substantially independent of the values in the welding process phases SPP and so these can be selected freely.

Similarly, the progress over time during the different welding process transitions SPÜ can differ (not illustrated). In general, the regulation or adaptation in the welding process transitions SPÜ takes place in dependence upon the welding process phases SPPs, since each welding process phase SPP has a different heat input into the workpiece W.

The welding process transition SPÜ is generally triggered e.g. at a pulse end or upon short circuit KS. These events can thus serve as the start/end of the welding process transition SPÜ. The duration of the welding process transition SPÜ can also be defined by a preset duration/cycle number. However, the adaptation of the transition welding parameters can also start before the beginning of the welding process transition SPÜ. If e.g. in a welding process SP, a very high wire advancing rate vd is necessary and, in the subsequent welding process SP, a very low wire advancing rate vd is necessary, in the last cycles of the current SP the wire advancing rate vd is already lowered. In this way, changes in the welding process transition SPÜ are not so abrupt and the welding process transition takes place in a more stable manner.

For example, in a welding process SP a transition or a switch can take place between a first welding process phase SPP-A (pulsed arc welding) and a second welding process phase SPP-B, e.g. short arc welding (either with a continuous wire advancing rate vd in the forwards direction or with cyclical forwards/backwards movement of the wire advancing rate vd). In the first welding process phase SPP-A (pulsed arc welding), the heat input is distinctly higher. For this reason, the arc length LBL is automatically longer than in the second welding process phase SPP-B (short arc). In order to switch from the first welding process phase A (pulsed arc welding) into the second welding process phase B (short arc phase) this difference in the arc length ΔLBL is automatically overcome by means of the method in accordance with the invention. When the arc length LBL of the welding process phase is increased not using the method in accordance with the invention SPP-A, a switch from the welding process phase SPP-A to the welding process phase SPP-B lasts longer and so the desired welding result may possibly no longer be achievable. With the method in accordance with the invention this is counteracted so that the desired welding result is achieved. In one possible embodiment, e.g. the wire advancing rate V_{D} of the welding wire electrode SDE is increased in parallel with an arc length change ΔLBL in the welding process transition SPÜ during the switch from SPP-A to SPP-B. In this way, the distance, i.e. the arc length distance, is overcome more quickly. With the method in accordance with the invention, the quality of the welding result in a welding process SP which comprises different types of welding process phases SPP can be distinctly increased.

In FIGS. 3A to 3C, welding process transitions SPÜ are illustrated in detail and by way of example. In FIG. 3B, the arc length LBL is reduced (−5), in FIG. 3C it is increased (+5). This takes place in a corresponding manner compared to FIG. 3A (+/−0). An essential factor in this is that by the selection or regulation of the transition welding parameters ÜSP, the duration of the welding process transition SPÜ is kept substantially constant. The regulation of the transition welding parameters ÜSP takes place in such a way that the target value is essentially approximately retained for the duration of the welding process transition SPÜ. This is achieved essentially through the regulation of the wire advance V_{D}.

### REFERENCE SIGNS

1 welding device
2 welding current source
3 welding torch
4 parameter store
5 controller
6 interface
7 network
8 controller
SP welding process
SPP welding process phase
SPÜ welding process transition
SDE welding wire electrode
W workpiece
LB welding arc

1. A method for stabilizing a welding process phase transition between different types of welding process phases of a welding process, wherein the welding process phases comprise different welding parameters,
wherein, at least in the welding process phases, a workpiece is welded in each case with a welding arc which extends between a welding wire electrode and the workpiece, and comprise an arc length parameter which can be set for the at least one welding process phase, SPP, wherein, during a welding process phase transition between successive different types of welding process phases, in the event of a change in the set arc length parameter of the welding arc, parallel thereto at least one transition welding parameter is automatically adapted in dependence upon the effected arc length parameter change in order to stabilize the welding process phase transition.

2. The method as claimed in claim 1, wherein the transition welding parameters comprise:
a wire advancing rate and/or wire advancing acceleration of the consumable welding wire electrode and/or
an amplitude and/or polarity of the average welding current flowing through the welding wire electrode
an amplitude and/or polarity of the welding voltage applied between the welding wire electrode and the workpiece and/or
a number and/or frequency of pulses of the welding current flowing through the welding wire electrode.

3. The method as claimed in claim 1, wherein with increasing or decreasing effected arc length change the wire advancing rate of the consumable welding wire electrode is automatically increased or reduced as a transition welding parameter in order to stabilize the welding process phase transition.

4. The method as claimed in claim 3, wherein with increasing or decreasing effected arc length changes the amplitude and/or the duration of the welding current and/or the amplitude of the welding voltage is/are automatically reduced or increased.

5. The method as claimed in claim 3, wherein with increasing or decreasing effected arc length change the number and/or the frequency of pulses of the welding current is/are automatically reduced or increased.

6. The method as claimed in claim 1, wherein for different combinations of pairs of successive different types of welding process phases of the welding process, in each case for different arc length changes which can be effected, associated configurable welding parameter sets of transition welding parameters are stored in tabular form in a parameter data set.

7. The method as claimed in claim 6 wherein in dependence upon the effected arc parameter change and the combination of the two successive different types of welding process phases, the associated welding parameter set is read out from the parameter data store and the corresponding transition welding parameters are adapted in order to stabilize the welding process phase transition between the two welding process phases.

8. The method as claimed in claim 1, wherein for different combinations of pairs of successive different types of welding process phases of the welding process transition function characteristic curves for different transition welding parameters are provided.

9. The method as claimed in claim 8, wherein, in dependence upon the effected arc parameter change and the associated stored transition function characteristic curves, parameter values for the different transition welding parameters are calculated during the welding process phase transition and the transition welding parameters are adapted according to the calculated parameter values in order to stabilize the welding process phase transition.

10. The method as claimed in claim 1, wherein the welding process phases comprise:
a short arc welding phase,
a long arc welding phase,
a pulsed arc welding phase,
a short arc welding phase with forwards or backwards movement,
a spray arc welding phase,
a welding phase with a rotating welding arc and/or
a transition arc welding phase.

11. A welding device for welding a workpiece in a welding process which comprises different types of welding process phases which comprise different welding parameters, in which the workpiece is welded in each case with a welding arc which extends between a welding wire electrode of the welding device and the workpiece, wherein for the welding process phases an arc parameter of the welding arc, in particular its arc length can be set,
wherein the welding device comprises a controller which, during a welding process transition between the different types of welding process phases of the welding process, effects a change in the arc parameter of the welding arc corresponding to the arc parameters set for the welding process phases and at the same time automatically adapts at least one transition welding parameter of a welding current source of the welding device in dependence upon the effected arc parameter change in order to stabilize the welding process transition within the welding process.

12. The welding device as claimed in claim 11, wherein, for the different welding process phases of the welding process, in each case associated arc parameter target values are set for the arc parameters to be used, which can each be adjusted within preset limits manually by a user using a setting element or by an external controller.

13. The welding device as claimed in claim 11, wherein for different combinations of pairs of successive different types of welding process phases of the welding process, in each case for different arc parameter changes which can be carried out, associated configurable welding parameter sets of transition welding parameters are stored in tabular form in a parameter data store of the welding device,
wherein, in dependence upon the effected arc parameter change and the combination of the two successive different types of welding process phases, the associated welding parameter set is read out from the data parameter store of the welding device and the corresponding transition welding parameters are adapted by the controller of the welding device in order to stabilize the welding process phase transition between the two welding process phases.

14. The welding device as claimed in claim 11, wherein for the different combinations of pairs of successive different types of welding process phases of the welding process transition function characteristic curves for different transition welding parameters are provided,
wherein, in dependence upon the effected arc parameter change and the associated stored transition function characteristic curves, parameter values for the different transition welding parameters are calculated during the welding process phase transition by a computing unit of the controller of the welding device and the transition welding parameters are adapted by the controller of the welding device in order to stabilize the welding process phase transition.

15. The welding device as claimed in claim 11, having an interface for loading welding parameter sets of the transition welding parameters and/or for loading transition function characteristic curves from a database.
